(19) United States
(12) Patent Application Publication
(10) Pub. No.: US 2007/0198347 A1
(43) Pub. Date: Aug. 23, 2007

(54) PROCESS FOR DISTRIBUTING PRODUCT ENTITLEMENTS TO MEMBERS OF A RETAIL STORE'S FREQUENT SHOPPER PROGRAM

(76) Inventor: James R. Muldoon, New York, NY (US)

Correspondence Address: KELLY LOWRY & KELLEY, LLP, 6320 CANOGA AVENUE, SUITE 1650, WOODLAND HILLS, CA, 91367, US

(21) Appl. No.: 11/550,691

(22) Filed: Oct. 18, 2006

Related U.S. Application Data
(63) Continuation-in-part of application No. 11/357,723, filed on Feb. 17, 2006.

(51) Int. Cl. G06Q 30/00

(52) U.S. Cl. 705/14

(57) ABSTRACT

A process for distributing entitlements in a retail store to shoppers who are members of that retail store's frequent shopper program that includes obtaining individual frequent shopper program member data from the retailer. Past product purchases of each frequent shopper program member are analyzed and categorized, and compared to a data file of available product entitlements. Upon entering their frequent shopper program member account code into a dispenser within the retailer's store, coupons or a list of entitlements are printed based upon the pre-selected available product entitlements to be associated with that particular frequent shopper program member. These entitlements are realized at the checkout stand of that retailer when the products are purchased within the allotted time frame.

### BACKGROUND OF THE INVENTION

This invention relates to a unique system and process that enables retailers (particularly supermarkets) to reward members of their frequent shopper programs more effectively. Specifically, the present invention is an in-store reward distribution system intended primarily for the retailer's exclusive use to build customer loyalty by providing its frequent shoppers with targeted, high-interest, high-value, conveniently-obtained rewards.

Consumer Packaged Goods companies (CPGs) spend over $150 billion annually in the United States on consumer advertising and promotion. Approximately 40% ($60 billion) of this expense is directed to advertising directed at the supermarket industry. CPGs are companies which produce national name brand products. For example, Nabisco™ manufactures and distributes such products as Oreos™, Triscuits™, etc. Kraft™ produces many goods, such as A1 Steak Sauce™, Stovetop Stuffing™, etc. Thus, it will be appreciated by those skilled in the art that these goods are advertised and distributed on a nationwide basis and virtually every supermarket or grocery store will carry national branded items, also referred to as CPG brands.

There are hundreds of billions of coupons distributed every year. About 90% are distributed via free-standing-inserts (FSI's), which are full-color, glossy inserts distributed in Sunday newspapers. However, over 98% of these free-standing-insert coupons are discarded, resulting in less than 2% being redeemed. The total value of the redeemed coupons exceeds $3.2 billion annually.

Current coupon redemption is down 3.42% from 1998, and down 7.5% from 1996. However, in-store and electronically-dispensed coupon distribution is up a dramatic 17.2% during this same period, with accompanying double-digit redemption rates. Packaged goods companies (CPG's) are looking for innovative ways to heighten redemption levels and increase coupon efficiency, and in-store systems are at the tops of their lists.

Just as packaged goods manufacturers are trying to build brand loyalty, supermarket retailers continually try to establish a special niche in their marketplace by building their store's own brand name. For example, a grocer or supermarket retailer labels competing goods under its own in-store or private label. Examples include the Select™ private label for Safeway™ stores, including Vons™, Pavilions™, Dominicks™, etc. Thus, a consumer entering a Safeway™ store, or any of its affiliated or owned stores, might find chocolate cookies with a white cream filling under the Select™ private label brand and placed adjacent to the Oreos™, the CPG national brand. Other supermarket chains, such as Albertsons (Essensia), Kroger/Ralphs (Private Selection), also have their own private labels or in-store branded goods. These private label goods are often sold for less than the national name brand CPG products, and usually provide a higher return to the grocer/supermarket retailer. However, due to various reasons, including the fact that many supermarket retailers have a regional geographic presence and that advertising is very expensive, usually only the CPGs are found in the free-standing coupon inserts (FSI's) delivered with the Sunday paper.

Thus, the supermarket/grocery retailers have two focal points in their niche marketing, namely the proliferation of store brands or private labels, and the use of their frequent shopper card programs. Both of these efforts build and maintain customer loyalty to that retailer's store(s). While the number of national brand items in the supermarket is becoming a smaller percentage of the total number of items in the store, frequent shopper card programs can encompass all of the approximately 30,000 stock keeping units (SKU's or stocked products) sold in the average supermarket, including store brands/private labels. Current industry analysis indicates that more than 70% of supermarket shoppers are enrolled in a mature frequent shopper program and that at least 85% of all sales are transacted with a frequent shopper card. More and more supermarket retailers are looking for “value added” enhancements to refresh their frequent shopper programs to help meet their original objectives.

Over 100 million frequent shopper membership cards are used daily in U.S. supermarket chains, which issue them to create shopper loyalty to the store. Industry experts agree that frequent shopper programs have fallen well short of their potential impact on business, due mostly to the chains' inability to make use of the tremendous purchase history databases they've built. When frequent shopper programs began, their main objective was to reward their best customers while encouraging other shoppers to also become best customers.

Unfortunately, the original objectives of frequent shopper programs have not come close to being achieved. Instead, they have simply become two-tiered pricing programs in which all members can get identical discounts on weekly “sale” items while all non-members are charged full retail prices. Further, since nearly all chains have frequent shopper programs, they are no longer points of differentiation.

What have been the impediments to retailer frequent shopper programs reaching their original objectives? One major impediment is that retailers don't have the headquarters personnel to properly “mine” their historical purchase databases because it costs too much. Even if they could afford it, they don't have a low-cost, efficient way to deliver frequent shopper program rewards to members.

This lack of “data-mining” capability can be traced to supermarkets being incredibly low-margin businesses (industry norm is a net profit of 1.5% of sales). This is compounded by the fact that the U.S. is currently “over stored” and suffering from stagnant population growth. Additionally, in the last 6 years supermarket retailers have faced enormous competitive pricing pressures from mass market supercenters (Wal-Mart™, Target™, etc.) which began to add full grocery stores to their traditional higher-margin, non-grocery product offerings. Supercenters can reduce prices on grocery categories while still enjoying acceptable store-wide margins because they also sell their traditional, higher-margin, non-grocery product mix. There has also been phenomenal growth in the warehouse clubs (Costco™, BJ's™, Sam's™, etc.) which have a wide assortment of both grocery and non-grocery best-sellers. Supplemented by annual membership fees, they work on a much tighter markup than traditional supermarkets, again forcing supermarket retailers to stay “lean and mean” at headquarters level in order to be price competitive.

Why don't retailers simply discontinue their frequent shopper programs, thus avoiding their ongoing costs? Two reasons:
(1) They're reluctant to write off the huge investment they have in their program; and
(2) They fear they'll be the only chain in their marketplace without a frequent shopper program.

There are a number of systems devised to deliver coupons in-store. One system utilizes in-store machines which are affixed to the shelf directly in front of the item for which the pre-printed coupon is available. The consumer must only take a coupon and purchase the associated product to redeem the coupon. The redemption rate for this system is approximately 17%, nearly nine times higher than conventional free-standing-inserts. However, this system is limited to the number of competing brands to which it can advertise because only one brand of product in each category can offer a coupon at any given time. The system is also limited to shelf space. Most importantly, the system does not promote the use of the supermarket's frequent shopper card program and cannot be targeted based on customers' historical purchasing patterns.

The second major system utilizes programmed coupon printers installed at each point of sale check-out cash register which monitor every item scanned during checkout. This system has a national brand coupon (CPG) programmed that competes with one of the customer's scanned (CPG) items and the printer will instantly produce a coupon for this competing (CPG) product. These coupons are typically valid for about four weeks. This system claims a redemption rate of nearly 10%, which is quite high considering that its coupons are inconvenient. Customers cannot use these coupons until their next shopping trip and often lose them. Additionally, they may not need to purchase the product category again anytime soon. For example, the purchase cycle for laundry detergent usually extends beyond the expiration of this type of coupon.

Inter-Act™, which is no longer in business, had provided interactive terminals near the entrance of the store. The customer used a touch screen to follow a series of commands to select a multimedia presentation of promotional offers, recipes and the like. The customer could then select which coupons they wished to use, print recipes, etc. Although the system, where implemented, had a relatively high redemption rate on coupons generated, the system had many drawbacks. The system was expensive as each interactive terminal was estimated to cost $20,000.00. The terminals also required a significant amount of maintenance due to their complexity. Furthermore, the system took a significant amount of time to navigate through all of the options, and many customers were unwilling to spend the time to go through the series of screens and options, or were intimidated by the high-tech terminals.

U.S. Pat. No. 6,321,208 Barnett, et al provides for “a method and system for the electronic distribution of product redemption coupons to remote personal computers located in users' homes.” Barnett teaches away from any “special purchase equipment” and teaches that an in-home PC with printer is needed to take full advantage of its “opt-in” coupon process. It further describes a “centrally located repository, such as an online service provider (OSP) . . . which stores packages of coupons for downloading on demand to user's computer . . . The user's demographic as well as coupon selection data is provided back to the OSP and coupon issuer and distributor for subsequent marketing analysis.” It also states that each coupon has a user-specific ID (examples cited are user's SSN or e-mail address) embedded in the coupon bar code whose primary purpose is to provide this information back to the product manufacturer (CPG). Because of the retailer's privacy pledge to its frequent shoppers, it would never allow this type of personal information to be shared through or associated with its frequent shopper program. In fact, Barnett teaches that coupons can be redeemed at any retailer who stocks that product. By contrast, a rebate issued by any supermarket frequent shopper program clearly states that the offer must be redeemed solely by that retailer.

Barnett's patent outlines the establishment of a manufacturer-controlled frequent buyer program designed to promote loyalty to specific Consumer Packaged Goods (CPG) brands, rather than to a retailer's frequent shopper program that is designed to promote loyalty to its stores. The fact that Barnett teaches that its coupons are brand-specific rather than retailer-specific would disqualify it from enhancing a retailer's frequent shopper program. It would actually degrade frequent shopper programs by sending shoppers to competitors' store and by providing private customer information to CPGs. Because of this, retailers would never include or link to a third-party marketing scheme that was manufacturer-controlled, and the Barnett system could never gain access to a retailer's frequent shopper database.

Barnett allows any customer to obtain any coupon and redeem it. It is meant to be utilized on a home computer with CPG brand redemption occurring at any store of the customer's choosing that stocks that CPG brand. The redemption information is then transmitted back to the manufacturer. This is a CPG brand-controlled system that does not require a frequent-shopper card, does not deliver coupons pre-selected and targeted by the retailer for its frequent shoppers based on purchase history, and is a stand-alone coupon distribution system which allows any shopper to get all available coupons and redeem them in any retailer's store of their choosing.

U.S. Pat. No. 5,857,175 to Day, et al provides a system wherein it issues a special “Day” card, that when swiped at a “Day” kiosk will print out a specific number of entitlements (identical number for every user). It then transmits the list of entitlements to each checkout stand. If the “Day card holder” re-swipes their “Day” card at the checkout and buys the item(s) on their “Day” lists of entitlements they get a discount off their bill. Day also teaches that the “Day” list can be taken to a competitor's store which also has a “Day” kiosk and receive the discount there instead.

Day also explains that once the card is swiped at the checkout stand its “closed loop” (kiosk to check stand to kiosk) architecture imports the transaction back to the “Day” in-store computer where it builds its own database of “Day” shopper purchase history profiles. Day builds its own frequent shopper program. But since it allows shoppers to leave one retailer and redeem at a competitor, it is not a retailer-specific frequent shopper program as detailed above. Also, Day does not utilize the retailer's single, preexisting frequent shopper program data, instead creating its own program, members and data. Moreover, in order to make targeted promotional offers to the customers, a product purchase history for each customer must be created. This takes a significant amount of time as most customers of a supermarket or grocery store only shop at that grocery store once or twice a week. In fact, Day states that initially the promotional offers are not targeted, but rather the same offers are provided to all of those who swipe their “Day” cards. It is unlikely that a retailer would want to have a third party come in and create a second frequent shopper program, which could compete with its own preexisting frequent shopper program. The retailer most certainly would not want to support such a system that provides discounts and rebates which could be used at a competitor's store.

Like Barnett, Day's process is CPG manufacturer-controlled and so its first loyalty is to the brands and not the retailer. Its goal is to maximize sales of sponsoring brands, not total store sales. Day claims shoppers “can get a list of special offers even when presenting a card from a competitor's chain of stores. Competitor's store will automatically set up a new account and purchase information is collected in competitor's store computer.” No retailer with a frequent shopper program would allow his shoppers' privacy to be compromised in this manner nor would he share historical purchase data with a competitor.

Accordingly, there is a need for a system or program that provides supermarkets with a way to refresh their frequent shopper programs in order to meet their original objective—reward best customers while encouraging others to become best customers. It also should allow the retailer to promote and build sales of his private label store brands and allow the retailer to incent his frequent shopper cardholders to purchase at various in-store service departments (fresh meat, fish, pharmacy, deli, bakery, etc.) that these shoppers have not historically visited while in the store, which also promote retailer loyalty. It should also become a one-to-one communications center, where the retailer can deliver personalized messages, coupons, rewards and incentives to each frequent shopper cardholder in a totally confidential and secure manner. To gain customer confidence, this system or program must be fast and convenient, and deliver rewards that are targeted (individualized) and of high perceived value. Additionally, these offers must be provided in-store at the beginning of—or during—the shopping trip. Since retailers pledge to protect frequent shopper privacy, a successful system for refreshing frequent shopper programs must be able to deliver targeted offers that are personalized only by previous purchase behavior without breaching the protective firewall built to assure customer privacy. Therefore, this system should not generate a purchase history database separate from the retailer's; develop user profiles as an “opt-in” requirement for additional benefits; embed any user-specific identity code on any coupon/reward dispensed to a shopper for ultimate third-party redemption; or issue a coupon for an item that can be redeemed in a competitor's store. The present invention fulfills these needs and provides other related advantages.

### SUMMARY OF THE INVENTION

The present invention resides in a process for distributing product entitlements in a retail store to shoppers who are members of that retail store's frequent shopper program, and thus their purchase history resides in the retailer's database. As mentioned above, many retailers, particularly those in the supermarket and grocery business, have established frequent shopper programs wherein shoppers can become members of the program to receive discounts that non-members are not entitled to. Most supermarket chains have had such a frequent shopper program in place for many years, and have tracked the past purchases of their frequent shopper program members.

In accordance with the present invention, the retailer provides data relating to its single, preexisting frequent shopper program. The frequent shopper program has preexisting members that have been each previously assigned a unique frequent shopper member account code by the retailer. The members of the frequent shopper program have made past purchases at the retailer's one or more stores in conjunction with their frequent shopper member account code.

The individual frequent shopper program member data is obtained from the retailer. This data includes individual frequent shopper program member account codes and related past purchases, with or without a coupon, made in conjunction with each individual frequent shopper program member account code. Typically, the past product purchases of each frequent shopper member account code are categorized into product categories. Each frequent shopper member account code may also be further categorized by at least one of: total dollars spent at the retailer over a predetermined period of time, average transaction amount, shopping frequency, etc. The past product purchase of each frequent shopper program member account code is compared to a data file of available product entitlements. The available product entitlements to be associated with each frequent shopper program member account code are selected based upon the one or more comparisons.

At least one dispenser is provided within the retailer's one or more stores, which is accessible to and activated by frequent shopper program member. This is done by entering information identifying the member's frequent shopper member account code. For example, the dispenser may be activated by swiping a card bearing a magnetic stripe or bar code containing the frequent shopper program member account code, or entering a number or code which is associated with the frequent shopper program member account code. The previously selected entitlements for that frequent shopper member account code are communicated to the dispenser, and these entitlements are printed at the dispenser. The entitlements may comprise coupons or rebates for Consumer Packaged Goods and/or the retailer's private label goods.

In one embodiment, individual coupons representing the previously selected entitlements are printed. These coupons include printed product information, rebate information and an electronically readable code thereon. The printed coupons are redeemed by scanning the electronically readable code on the printed coupon at the point-of-sale checkout stand, and matching the scanned coupon codes to universal product codes (UPC's) of purchased products scanned at the point-of-sale checkout stand.

In another embodiment, a list of the previously selected entitlements is printed. The list includes a list of products and rebate information for each listed product. Preferably, the list includes an electronically readable code which identifies the frequent shopper program member account code. The printed list may be organized in such a manner that the frequent shopper program member is led through the retail store from the dispenser to the point-of-sale checkout in a convenient manner. The printed coupons or list may include the aisle number in which each product can be found. In the embodiment wherein a list of product entitlements is printed, the previously selected list of entitlements sent to the dispenser and printed is relayed to a retail store computer in order to allow the matching of the list of entitlements to products purchased at the point-of-sale checkout.

In one particularly preferred embodiment, each frequent shopper program member's past purchases from in-store fresh and service departments is analyzed. Each frequent shopper member account code is categorized according to past purchases made from in-store fresh or service departments over time. At least one entitlement is provided to the frequent shopper program member for use in association with an in-store fresh or service department of the retailer.

In another particularly preferred embodiment, frequent shopper members in the retailer's store are notified of a limited time entitlement offer. The entitlement is printed at the dispenser to those frequent shopper members that activate the dispenser within the limited time of the entitlement offer. Frequent shopper program members may be notified of the limited time offer by verbal or visual announcement within the retailer's store. For example, the verbal announcement may be made over a public address system, or a visual announcement provided over an electronic display or the like.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic block diagram illustrating the interaction of various components which comprise the system of the invention as they relate to a paper coupon embodiment thereof;

FIG. 2 is a schematic block diagram illustrating the interaction of various components which comprise the system of the invention as they relate to a list of entitlements embodiment thereof; and

FIG. 3 is a flowchart illustrating the several steps taken during the process of the present invention.

### DETAILED DESCRIPTION OF THE PREFERRED EMBODIMENTS

As shown in the drawings, for purposes of illustration, the present invention resides in a process for distributing product entitlements in a retail store to shoppers who are members of that retail store's frequent shopper program. The invention provides the retailer (typically a supermarket or grocer) with a way to refresh and enhance their single, preexisting frequent shopper programs. As described above, many supermarket and grocery retailers have implemented frequent shopper programs. Customers of the retailer sign up for the frequent shopper program and are issued a unique identifying code. A customer typically fills out a form providing their name, address, telephone number, and sometimes additional information. The customer is typically provided with an electronically readable card, having a magnetic stripe or a bar code or the like. In some instances, multiple cards or keychain tags are issued to the same household, such that the same frequent shopper program account is set up for that household. In that way, when either the husband or wife shops at the retailer, the complete past purchase history for the entire household is gathered. Also, this enables the accounts to be accessed by a household code, such as the household telephone number, when either the husband or wife forgets to bring their frequent shopper program card or keychain tag to the store, and instead enters their telephone number to obtain the benefits of the frequent shopper program.

As mentioned above, although many supermarkets and grocery retailers have implemented these frequent shopper programs, which have generated a tremendous amount of past purchase history for each frequent shopper program account over the last several years, the retailers have not been able to utilize this information in any efficient, or even effective, manner. However, given the investment into the frequent shopper program and the fact that competitor retailers also have such frequent shopper programs, the retailers have not abandoned these programs and instead these programs have become essentially a two-tier pricing structure. Rebates or discounts are provided on a number of products throughout the store which are available to all frequent shopper program members, but which are not available to non-members.

The present invention is designed to utilize the data which has been captured and stored for past product purchases by the retailer's frequent shopper program members to the benefit of the retailer. The system and process of the present invention are controlled by the retailer and enable the retailer to target offers or entitlements to members of their frequent shopper program in a very specific manner. The present invention also enables the retailer to offer entitlements or rebates for not only national brand consumer packaged (CPG) goods, but also the retailer's own in-store or private label goods and the retailer's in-store fresh or service departments (including the deli, bakery, produce, meat, floral and pharmacy departments). The present invention, as more fully discussed herein, also enables the retailer to make time limited offers, typically to shoppers who are present at the retailer's store at the time the limited time offer is given. As will be appreciated by those skilled in the art, this enables the retailer to encourage their frequent shopper program members to purchase the retailer's private label goods and visit and make purchases in their in-store service/fresh departments, which have a higher profit margin than the Center Store, which aisles are full of shelf-stable Consumer Packaged Goods. The present invention is able to accomplish these objectives while maintaining the privacy and secrecy of sensitive frequent shopper program member data, including the names, addresses, social security numbers, etc. of the frequent shopper program members. The present invention, as is more fully described herein, also achieves these objectives while being retailer controlled instead of (CPG) manufacturer controlled.

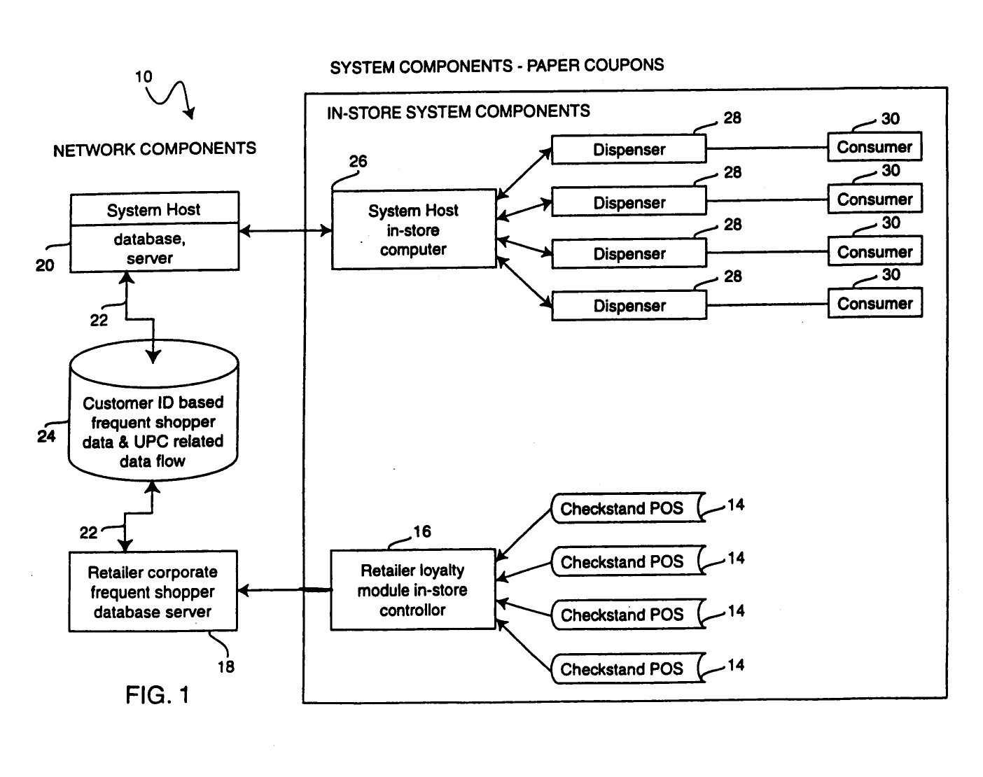

Referring to FIG. 1, it is common for retailers with a frequent shopper program to track and transfer member purchase information, including individual account numbers and related product purchase history detailing each purchase transaction when the membership card is used (from the check stand 14 to an in-store computerized controller module 16). Periodically, the in-store computer 16 transfers the accumulated information to a retailer corporate frequent shopper database server 18. This server 18 accumulates frequent shopper information over time in order to improve the retailer's frequent shopper program and increase its revenues.

System host server 20 establishes a two-way communications link 22 with the retailer central server 18 for the capturing and copying of frequent shopper program member data, including individual member account codes and related Universal Product Code (UPC) product purchase history information 24. The current invention tracks purchase histories and patterns for each account code, so personal information such as name, address, etc. is not seen. Every frequent shopper program pledges to every member when they enroll that they will not share their information with any third party that might use it to contact that shopper by e-mail, direct mail, telephone, or any other means. Supermarkets only have one real asset, which is their customer base. In today's super competitive environment, a retailer would never risk an outside party invading a customer's privacy by exploiting confidential frequent shopper personal information. Thus, a retailer would not allow a CPG to data mine their frequent shopper program databases, as it could place the retailers in a vulnerable position regarding the proprietary information. CPGs often purchase such information from others in order to direct market to consumers. Thus, the retailer is very protective of the information contained in their frequent shopper program database and shields this information to a great extent from CPGs (Consumer Packaged Goods)/national brand manufacturers. The present invention alleviates these concerns by not capturing the personally identifying, private data. Moreover, the system and process are controlled by the retailer as the system and process are managed by the retailer. Nothing occurs without the prior approval of the retailer.

The captured data is sorted by frequent shopper program member account code and the purchase history for each account code is categorized or sorted by product category. The frequent shopper program member account code, which now has a corresponding categorized product history, is compared to a data file typically maintained by the host system which is populated with available product entitlements. A unique, highly-targeted “set” of product entitlements is selected for each member account code. These sets of unique entitlements are transmitted to the system host computers 26 which reside in retail stores.

Therefore, a part of the inventive process is the development and use of a software package that allows the system to command sorting of frequent shopper data from the retailer T-logs (transaction data files). These data sorts include:
(1) Identifying each frequent shopper account code;
(2) Determining which individual store location(s) of the retailer that the frequent shopper cardholder shops at (historically);
(3) Sorting all Stock Keeping Units (SKU's) in retailer T-logs into standard industry product categories;
(4) Determining purchase cycle (frequency) by product category from retailer database by frequent shopper member;
(5) Contrasting each frequent shopper account's purchasing cycle against a paradigm developed by analyzing a multitude of such accounts' purchases on a “by product category” basis;
(6) Using this comparative analysis of purchasing patterns to classify the individual frequent shopper as having a “heavy,” “normal,” “light,” or “non” consumption level of that category;
(7) Completing this process “by brand”; and
(8) Contrasting each frequent shopper's purchasing cycle against a paradigm developed by analyzing a multitude of such accounts' purchases on a “by in-store department” basis.

The development and implementation of this matrix allows delivery of the most highly targeted possible entitlements on a customer-specific basis.

When the initial sorting and categorizing procedure has been completed (it is organized perpetually the corporate system host database server 20 will have pre-qualified each frequent shopper for their “entitlements” (coupons and discounted offers). The system matches available offers to pre-qualified recipients. The system employs algorithm software to match purchasers' cycle history to available promotional offers. Based on a predetermined hierarchy, the system prioritizes the offers to be generated. Once the process has been completed, the appropriate offers are populated by frequent shopper account. All this is performed with the foreknowledge and approval of the retailer.

In one embodiment the host system database server 20 will pull back the complete file of pre-selected, targeted entitlements on a customer-specific basis. When this is completed, the system periodically downloads customer-specific entitlement files for every frequent shopper member account to the system's in-store data management file computer 26 where they remain cached awaiting activation by one of the in-store dispensers 28. A complete customer-specific entitlement file will be downloaded to every store location where each frequent shopper member account has been used in the prior six months.

Entitlement dispensers 28 are installed in every store location. The dispensers 28 include a memory device, a communications device, a printer, and means for identifying frequent shopper account codes. This may include a mag-stripe reader, a bar code scanner, and/or a keypad for manual entry of membership numbers and PINs. At least one, and preferably multiple, dispensers 28 are located strategically throughout the store. For instance, one or more dispensers 28 can be placed near each entrance. Other dispensers 28 can be placed throughout the store. Placements near high-profit perimeter departments can be particularly effective in implementing and delivering “timely offer” coupons offered to “present shoppers” as will be more fully explained herein.

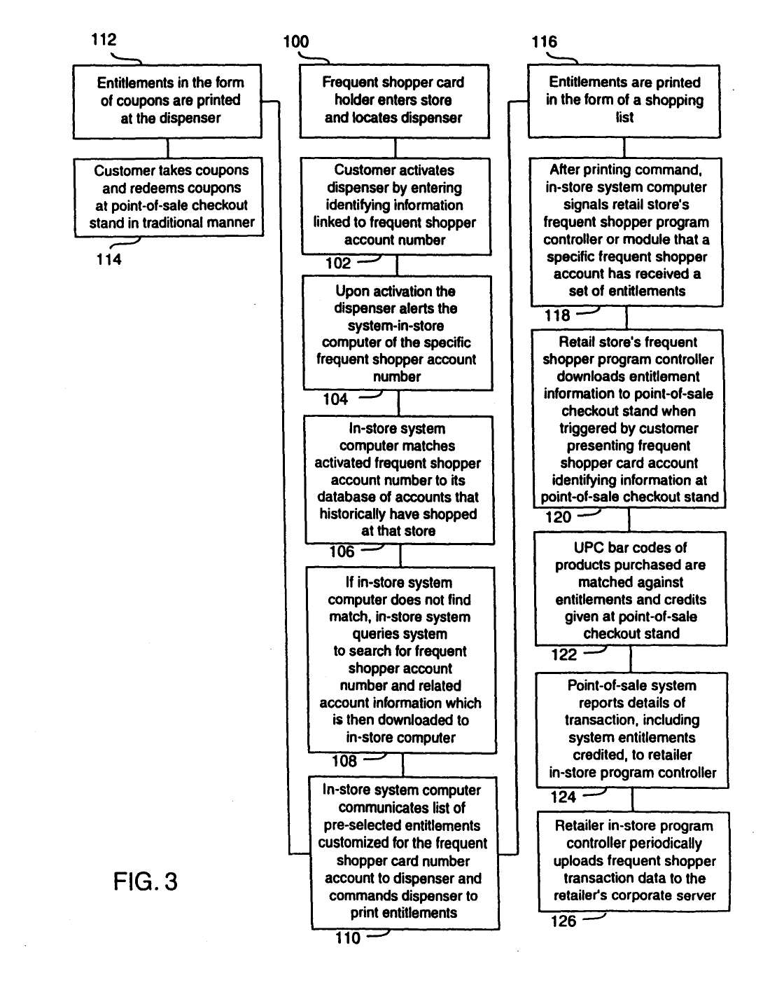

FIG. 3 is a flowchart that illustrates the steps taken during the process of acquiring and redeeming product entitlements. The process begins when frequent shopper members enter a store and locate a dispenser 28 (100). Members activate dispensers 28 by entering identifying information linked to their frequent shopper account code or number (102) by swiping a magnetic card through a reader, scanning a bar code, or manually keying in a number or code. The card bearing the magnetic stripe or bar code is the frequent shopper program member card issued by the retailer. If the customer does not have the card or keychain tag, the customer may enter a predetermined code, number, etc. (such as the household telephone number) into the key pad of the dispenser 28 which is associated with the customer's frequent shopper program member account. The present invention utilizes the retailer's single, preexisting frequent shopper program, and does not create its own program, or even a secondary frequent shopper program for the retailer.

Upon activation, dispensers 28 notify the system's in-store computer 26 of the member's account number or code (104). The in-store system computer 26 matches the activated account to its file of members who historically shop in that store (106). If the in-store system computer 26 cannot find a match, it queries the host system master account file 20 to locate the account and related information and then download it to the in-store computer 26 (108). The in-store system computer 26 sends the list of pre-selected entitlements customized for the frequent shopper to the dispenser 28 and commands it to print entitlements (110).

In one preferred embodiment, illustrated in FIG. 1, entitlements are printed as coupons by the dispenser 28 (112). These coupons mimic standard free-standing insert coupons which include product name, size, rebate offered, and bar code or other electronically readable code for redemption. The coupon may also include a graphic product representation or logo. Coupons can be printed on designed paper or include a colored border or printed in full color to prevent fraudulent copying. Coupons also include expiration dates which may extend several weeks or months from date of printing or only for that day. The coupons are also printed with the legend, “redeemable only at this retailer”. The present invention, unlike the prior art such as the Barnett and Day patents, provides coupons and entitlements which are only redeemable through that particular retailer. That is, the entitlements are retailer specific, and cannot be used in the retailer's competitors' stores. This is the case whether the coupons are for CPG, national branded goods, the retailer's in-store/private label goods, or rebates and offers for the retailer's in-store fresh/service departments.

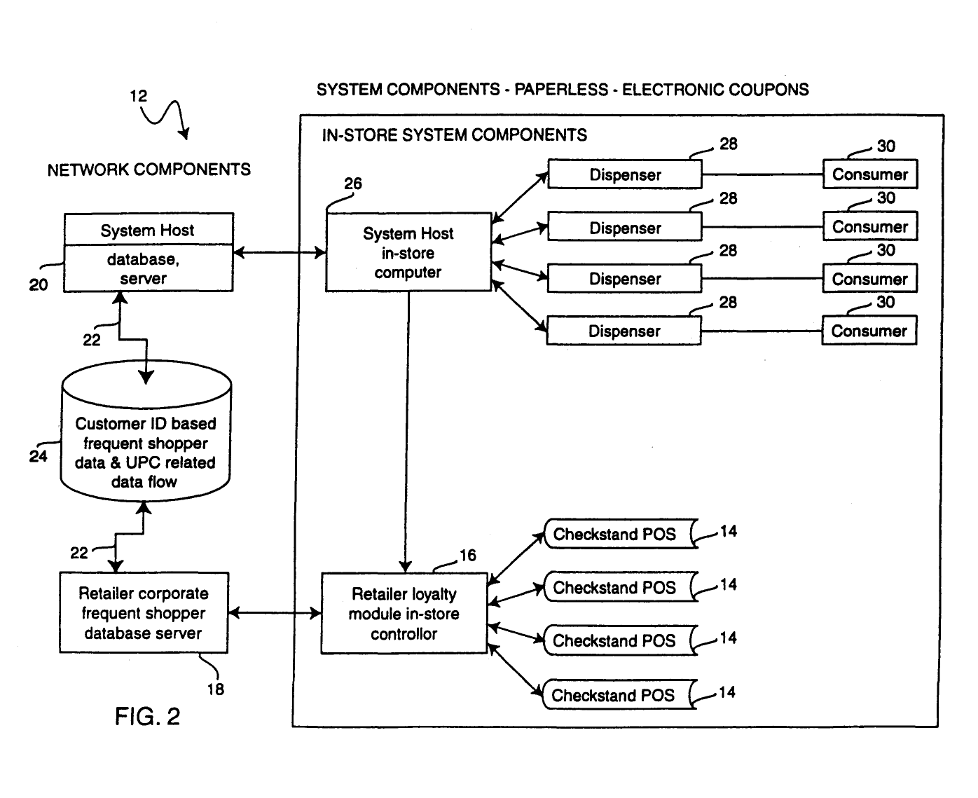

Another preferred embodiment of the present invention is illustrated graphically in FIG. 2. This embodiment is similar to the first embodiment because the system host server 20 establishes a link 22 with the retailer central server 18 for capturing and copying member data, including individual member account numbers and related Universal Product Code (UPC) product purchase history information 24. Personal information such as name, address, etc. is not captured. The captured data is sorted by member account number and the product purchase history for each account number is categorized into various categories. These various product categories can include several hundred product categories in which similar products are categorized.

The member account number which now has a corresponding categorized product history is compared to a data file typically maintained by the host system which houses available product entitlements. A list of product entitlements is selected for each member account number. It is then determined which retail store or stores the various frequent shopper program members visit. A copy of the list of product entitlements is then sent to a system host computer 26 having a data file of every frequent shopper card holder who has historically shopped in that store and which resides in each retail store, where they are cached awaiting activation.

Entitlement dispensers 28 are provided in each participating retail store location. The dispensers 28 include a memory device, a communications device, a printer, and means for identifying frequent shopper program members account numbers. Such a means can include a magnetic card reader, a bar code scanner and/or a keypad for the manual insertion of a number identifying the member account number. At least one, and preferably multiple, dispensers 28 are located strategically throughout the retail store. For instance, one or more dispensers 28 can be placed near each entrance to the retail store. Other dispensers 28 can be placed throughout the store, such as at the bakery, meat department, etc. to more easily execute the retailer's ability to distribute “timely offers” to “present shoppers”, frequent shoppers currently in the store, thereby possibly attracting them to departments they don't shop on a routine basis. The dispensers 28 are used to print the previously selected list of entitlements when activated by a frequent shopping program member 30 whose account has been tracked, captured, and a corresponding list previously prepared.

Referring again to FIG. 3, the process begins when the frequent shopper card holder enters the store and locates the dispenser 28 (100). The frequent shopper card holder customer activates the dispenser 28 by entering identifying information linked to their particular frequent shopper account code (102). This is done by swiping a magnetic card through a reader, scanning a bar code, or manually keying in a number or code which identifies the member's account code.

Upon activation, the dispenser 28 alerts the system's in-store computer 26 of the specific frequent shopper account number which activated the dispenser 28 (104). The in-store system computer 26 matches the activated frequent shopper account code to its list of accounts that historically have shopped that store (106). If the in-store system computer 26 cannot find a match, it queries host system master data file 20 to search for frequent shopper account code and related account information which is then downloaded to the in-store computer 26 (108).

The in-store system computer 26 then communicates the list of pre-selected entitlements which are customized for the frequent shopper card number account to the dispenser 28 and commands the dispenser 28 to print entitlements (110). In this embodiment, the dispenser 28 prints a list of entitlements (116). The entitlement list includes a single sheet of paper listing of products and their brand name and size which are subject to the entitlements and the rebate or entitlement amount for each product. The entitlement list may also include a bar code or other electronically readable code identifying the customer as a specific frequent shopper program member of that retailer at the point-of-sale check stand 14. Preferably, the entitlement list is organized according to the order in which the products subject to entitlements will be encountered in the store in order to convenience the customer. For example, if the dispenser 28 is located near an end of the store having a cereal aisle adjacent thereto, a cereal entitlement would appear near the top of the entitlement list. If in the same scenario beauty products were to be at the opposite end of the store, a beauty product entitlement would be placed near the bottom of the list. The aisle number where the product can be located may be printed on the list adjacent to the product subject to the entitlement.

Retailers will be provided with an identical set of pre-selected entitlements by frequent shopper account code by store, so they can execute the delivery and crediting of the entitlements at customer checkout 14. Therefore the system gives retailers the means to accept the identical list of pre-selected entitlements that system host 20 develops and downloads to the system host in-store computer 26 for in-store caching of entitlements awaiting frequent shopper activation at one of the in-store dispensers 28.

This identical list of pre-selected entitlements will reside in the retailer's corporate frequent shopper database server 18. The system further provides the means for the corporate server 18 to download the entitlements by store where they are cached until the in-store computer 26 signals the retailer in-store controller 16 that a specific set of entitlements has been activated by a frequent shopper.

After the print command is sent, the in-store system computer 26 signals the retail store's frequent shopper controller or module 16 that a frequent shopper account has received a set of entitlements (118). Referring to FIG. 2, note that there is a one-way communication line from the in-store system computer 26 to the retailer controller module 16 for this purpose.

The store's frequent shopper controller downloads entitlement information to the checkout stand 14 used by the frequent shopper. The check stand 14 is determined when the frequent shopper presents their account number (membership card). As the product bar codes are scanned, matches are made against the entitlements which have been downloaded, and credits are immediately awarded.

The point-of-sale system reports the details of the transaction, including system entitlements credited, to the retailer's in-store program controller 16 (124). Retailer in-store program controllers then periodically upload frequent shopper transaction data to their corporate server 18 (126).

As the present invention is retailer controlled, and not manufacturer controlled, the retailer can provide its entitlements for its own private label goods. Thus, for example, the retailer can provide an entitlement for its in-store brand or private label toasted rice cereal. Of course, the present invention could also dispense entitlements for national branded or CPG goods, such as the corresponding Kelloggs Rice Krispies™. However, all prior systems which have been proposed are based upon nationally branded, or CPG goods, and have not been designed to enable the retailer to promote offers or entitlements of its own private label goods. This is due to the fact that the prior art systems either work closely in conjunction with the national brand manufacturers or distributors, or were manufacturer or distributor controlled. However, the present invention is controlled by the retailer, enabling the retailer to make such entitlements of its own store branded goods. It should be understood, however, that the printed coupons or list of entitlements could include both private label as well as CPG goods.

The present invention also enables the retailer to utilize the data it has acquired in association with its in-store departments, such as the deli, meat, bakery, produce, pharmacy, etc. These in-store departments are often times referred to as “fresh” or “service” departments. These departments typically have a higher profit margin as compared to the “grocery” department of the retailer. It would be highly desirable for a retailer to be able to encourage its customers to visit these departments and make purchases, and particularly visit departments which have not been visited frequently, or ever, by the customer in the past.

In accordance with the present invention, when the data of the retailer's frequent shopper program is provided, the invention analyzes each frequent shopper program member's past purchases from in-store fresh and service departments. Each frequent shopper program member account code or number is categorized according to past purchases made from these in-store fresh or service departments over time. Preferably, at least one entitlement (printed coupon or included on the list of entitlements) is provided to the customer for use in association with an in-store fresh or service department of the retailer.

This can be used advantageously by the retailer, such as providing an entitlement to a customer who frequently shops at one of the retailer's in-store fresh or service departments. For example, if the customer frequently purchases fresh bread or donuts from the bakery, an entitlement may be given to that particular customer for another item such as a cake or pie. Alternatively, if it is determined that the customer has never, or rarely, visits an in-store department, such as the pharmacy or floral, an entitlement can be given in that department in order to encourage the customer to visit that in-store department and make a purchase from that department. Of course, only the retailer having a preexisting frequent shopper program would have data on the past purchase history of customers from those in-store departments of that retailer. Moreover, only the retailer would have any interest in providing entitlements or offers to customers to make purchases from its own in-store fresh and service departments. Prior art systems which are manufacturer driven simply are not designed to have access to such information nor give offers in the retailer's own in-store departments.

Due to the design of the system of the present invention, retailers can also make limited time entitlement offers to its frequent shopper program members. Such offers could have a limited time which spans over several days to as short of a time frame as 30 minutes or less. This embodiment is particularly suited for those frequent shopper members who are presently in the retailer's store, and thus such limited time entitlement offers are “timely” offers, or “present shopper” offers. For example, the retailer may want to offer an entitlement for a particular item or for use in a particular in-store fresh or service department. Customers within the retailer's store are notified of the limited time entitlement offer. This can be done, for example, by making either a verbal announcement, such as over a public address system within the store, or a visual announcement provided by signage, an electronic display or the like. Those customers within the store who are members of the retailer's frequent shopper program can approach a dispenser 28 of the system of the present invention, swipe their card or otherwise enter their account code, and be provided with a printed coupon or entitlement for the limited time offer.

For example, the retailer may want to offer a limited time entitlement offer for donuts after 9:00 a.m. Thus, customers within the store are notified that frequent shopper card holders are entitled to a discount, such as $1.00 off a dozen donuts. Frequent shopper program members approach the dispenser of the present invention, obtain the entitlement, purchase the donuts, and are given the discount at the checkout stand. Such “present shopper” limited time entitlement offers can be made in any fresh or service department of the store, or for any goods within the store. For example, a discount may be provided to those present shoppers over a time period set by the retailer for discount on dip when a particular brand of chips is purchased. This limited time entitlement offer could be made available for a very short time period such that only those shoppers present at the time the offer is made will be able to take advantage of the offer, or can extend for the entire day, or even over multiple days depending upon the need and desire of the retailer.

It will be appreciated by those skilled in the art that the present invention provides a retailer with a one-to-one communications center with its frequent shopper card holders. Although provided by a third party, the system is retailer-controlled and every coupon has retailer approval and can only be redeemed in its store. Retailers are able to reward their frequent shopper program members with targeted coupons and entitlement offers. Moreover, only frequent shopper program members are allowed to take advantage of the “present shopper” limited time entitlement offers. Another unique feature of the present invention is that frequent shopper program members are offered substantial discounts and savings by purchasing products from in-store fresh or service departments that they may never have visited before, or only very infrequently shopped. This is also of benefit to the retailer as the in-store departments are highly profitable. Providing discounts to the retailer's private label goods and in-store fresh and service departments, it is believed, will heighten the loyalty of the shopper to that particular retailer, which was the original intention of frequent shopper programs.

Although several embodiments have been described in detail for purposes of illustration, various modifications may be made without departing from the scope and spirit of the invention. Accordingly, the invention is not to be limited, except as by the appended claims.

What is claimed is:

1. A process for distributing product entitlements in a retail store to shoppers who are members of that retail store's frequent shopper program, comprising the steps of:
a retailer providing data relating to its single, preexisting frequent shopper program, the frequent shopper program having preexisting members that have been each previously assigned a unique frequent shopper member account code by the retailer, a plurality of the members having made past purchases at the retailer's one or more stores in conjunction with their frequent shopper member account code;
obtaining individual frequent shopper program member data from the retailer, including individual frequent shopper program member account codes and past purchases, with or without a coupon, made in conjunction with each individual frequent shopper program member account code;
comparing the past product purchases of each frequent shopper program member account code to a data file of available product entitlements;
selecting available product entitlements to be associated with each frequent shopper program member account code based on the comparison;
providing at least one dispenser within the retailer's one or more stores which is accessible to and activated by a frequent shopper program member by entering information identifying the member's frequent shopper member account code;
communicating the previously selected entitlements for that frequent shopper member account code to the dispenser; and
printing the previously selected product entitlements at the dispenser.

2. The process of claim 1, including the step of categorizing the past product purchases of each frequent shopper member account code into product categories.

3. The process of claim 1, wherein the printing step includes printing coupons representing the previously selected entitlements, wherein the printed coupons include product information, rebate information, an expiration date, a legend “redeemable only at this store” and an electronically readable code thereon.

4. The process of claim 3, including the step of redeeming the printed coupons by scanning the electronically readable code on the printed coupon at the point-of-sale checkout stand and matching the scanned coupon codes to universal product codes of purchased products scanned at a point-of-sale checkout stand.

5. The process of claim 1, wherein the printing step includes printing a list of the previously selected entitlements, including a list of products and rebate information for each listed product.

6. The process of claim 5, wherein the printed list is organized in such a manner that the frequent shopper program member is led through the retail store from the dispenser to the point-of-sale checkout in a convenient manner.

7. The process of claim 5, wherein the printed coupons or list includes the aisle number in which each product can be found.

8. The process of claim 5, wherein the list includes an electronically readable code which identifies the frequent shopper program member account code.

9. The process of claim 5, including the step of relaying the previously selected list of entitlements sent to the dispenser to a retail store computer in order to allow the matching of the list of entitlements to products purchased at the point-of-sale checkout.

10. The process of claim 1, wherein the dispenser is activated by swiping a card bearing a magnetic strip or bar code containing the frequent shopper program member account code, or entering a number or code which is associated with the frequent shopper program member account code.

11. The process of claim 1, wherein the selecting entitlements step includes the step of providing at least one entitlement for a consumer packaged good.

12. The process of claim 1, wherein the selecting entitlements step includes the step of providing at least one entitlement for a retailer private label good.

13. The process of claim 1, including the step of analyzing each frequent shopper program member's past purchases from in-store fresh and service departments.

14. The process of claim 13, including the step of categorizing each frequent shopper member account code according to past purchases made from in-store fresh or service departments over time.

15. The process of claim 13, including the step of providing at least one entitlement for use in association with an in-store fresh or service department of the retailer.

16. The process of claim 1, including the step of categorizing each frequent shopper member account code by at least one of: total dollars spent at the retailer over a predetermined period of time, average transaction amount, or shopping frequency.

17. The process of claim 1, including the step of notifying frequent shopper members in the retailer's store of a limited time entitlement offer and printing the entitlement at the dispenser to those frequent shopper members that activate the dispenser within the limited time of the entitlement offer.

18. The process of claim 17, wherein the notifying step includes the step of making a verbal announcement or visual announcement within the retailer's store of the limited time entitlement offer.

19. The process of claim 17, wherein the verbal announcement is made over a public address system, and the visual announcement is provided over an electronic display.

20. A process for distributing product entitlements in a retail store to shoppers who are members of that retail store's frequent shopper program, comprising the steps of:
a retailer providing data relating to its single, preexisting frequent shopper program, the frequent shopper program having preexisting members that have been each previously assigned a unique frequent shopper member account code by the retailer, a plurality of the members having made past purchases at the retailer's one or more stores in conjunction with their frequent shopper member account code;
obtaining individual frequent shopper program member data from the retailer, including individual frequent shopper program member account codes and past purchases, with or without a coupon, made in conjunction with each individual frequent shopper program member account code;
comparing the past product purchases of each frequent shopper program member account code to a data file of available product entitlements;
categorizing the past product purchases of each frequent shopper member account code into product categories;
categorizing each frequent shopper member account code according to past purchases made from in-store fresh or service departments over a predetermined period of time;
selecting available product entitlements to be associated with each frequent shopper program member account code based on the comparison and categorizations, the entitlements including at least one entitlement for a retailer private label good or at least one entitlement for use in association with an in-store fresh or service department of the retailer;
providing at least one dispenser within the retailer's one or more stores which is accessible to and activated by a frequent shopper program member by entering information identifying the member's frequent shopper member account code, wherein the dispenser is activated by swiping a card bearing a magnetic strip or bar code containing the frequent shopper program member account number, or entering a number or code which is associated with the frequent shopper program member account code;
communicating the previously selected entitlements for that frequent shopper member account code to the dispenser;
printing the previously selected product entitlements at the dispenser by printing coupons representing the previously selected entitlements, wherein the printed coupons include product information, rebate information and an electronically readable code thereon; and
redeeming the printed coupons by scanning the electronically readable code on the printed coupon at the point-of-sale checkout stand and matching the scanned coupon codes to universal product codes of purchased products scanned at a point-of-sale checkout stand.

21. The process of claim 20, including the step of notifying frequent shopper members in the retailer's store of a limited time entitlement offer and printing the entitlement at the dispenser to those frequent shopper members that activate the dispenser within the limited time of the entitlement offer by making a verbal announcement or visual announcement within the retailer's store of the limited time entitlement offer.

22. A process for distributing product entitlements in a retail store to shoppers who are members of that retail store's frequent shopper program, comprising the steps of:
a retailer providing data relating to its single, preexisting frequent shopper program, the frequent shopper program having preexisting members that have been each previously assigned a unique frequent shopper member account code by the retailer, a plurality of the members having made past purchases at the retailer's one or more stores in conjunction with their frequent shopper member account code;
obtaining individual frequent shopper program member data from the retailer, including individual frequent shopper program member account codes and past purchases, with or without a coupon, made in conjunction with each individual frequent shopper program member account code;
comparing the past product purchases of each frequent shopper program member account code to a data file of available product entitlements;
categorizing the past product purchases of each frequent shopper member account code into product categories;
categorizing each frequent shopper member account code according to past purchases made from in-store fresh or service departments over a predetermined period of time;
selecting available product entitlements to be associated with each frequent shopper program member account code based on the comparison and categorizations, the entitlements including at least one entitlement for a retailer private label good or at least one entitlement for use in association with an in-store fresh or service department of the retailer;
providing at least one dispenser within the retailer's one or more stores which is accessible to and activated by a frequent shopper program member by entering information identifying the member's frequent shopper member account code, wherein the dispenser is activated by swiping a card bearing a magnetic strip or bar code containing the frequent shopper program member account number, or entering a number or code which is associated with the frequent shopper program member account code;
communicating the previously selected entitlements for that frequent shopper member account code to the dispenser;
printing the previously selected product entitlements at the dispenser by printing a list of the previously selected entitlements, including a list of products and rebate information for each listed product; and
relaying the previously selected list of entitlements sent to the dispenser to a retail store computer in order to allow the matching of the list of entitlements to products purchased at the point-of-sale checkout.

23. The process of claim 22, including the step of notifying frequent shopper members in the retailer's store of a limited time entitlement offer and printing the entitlement at the dispenser to those frequent shopper members that activate the dispenser within the limited time of the entitlement offer by making a verbal announcement or visual announcement within the retailer's store of the limited time entitlement offer.
